(19) United States
(12) Patent Application Publication
(10) Pub. No.: US 2025/0224488 A1
(43) Pub. Date: Jul. 10, 2025

(54) RADAR DEVICE

(71) Applicant: Mitsubishi Electric Corporation, Tokyo (JP)

(72) Inventors: Yusuke KITSUKAWA, Tokyo (JP); Noriyuki FUKUI, Tokyo (JP)

(73) Assignee: Mitsubishi Electric Corporation, Tokyo (JP)

(21) Appl. No.: 19/095,511

(22) Filed: Mar. 31, 2025

Related U.S. Application Data
(63) Continuation of application No. PCT/JP2022/044494, filed on Dec. 2, 2022.

(51) Int. Cl. G01S 7/35; G01S 7/02

(52) U.S. Cl. CPC G01S 7/354; G01S 7/0232; G01S 7/356; G01S 7/358

(57) ABSTRACT

A radar device includes: a beat signal generation unit to generate an I-axis local oscillator signal and a Q-axis local oscillator signal from a local oscillator signal that is a real signal, mix the I-axis local oscillator signal and a received signal to generate an I-axis beat signal, and mix the Q-axis local oscillator signal and the received signal to generate a Q-axis beat signal; and a signal processing unit to perform signal processing on I-axis digital data and Q-axis digital data obtained by sampling the I-axis beat signal and the Q-axis beat signal, and the signal processing unit generates complex digital data from the I-axis digital data and the Q-axis digital data, performs two-dimensional FFT on the complex digital data, and measures a range and a Doppler velocity of an observation target on the basis of a property that an analytic signal does not have a negative frequency component.

### CROSS REFERENCE TO RELATED APPLICATIONS

This application is a Continuation of PCT International Application No. PCT/JP2022/044494 filed on Dec. 2, 2022, all of which is hereby expressly incorporated by reference into the present application.

### TECHNICAL FIELD

The present disclosure relates to a radar device.

### BACKGROUND ART

There are known radar devices that are mounted on vehicles. Furthermore, as for the radar devices mounted on vehicles, there is known a technique of suppressing occurrence of a radio wave interference with a radar signal of other vehicles.

For example, Patent Literature 1 describes a technique that includes a camera that photographs an area including a direction to which a radar signal is transmitted, and makes a transmission section of an own vehicle and a transmission section of another vehicle different on the basis of a lighting state of a light of the another vehicle included in an image shot by the camera.

Furthermore, Patent Literature 1 also discloses that a fast chirp system is advantageous for separation and detection of a plurality of targets.

### CITATION LIST

### Patent Literature

Patent Literature 1: JP 2016-224024 A

### SUMMARY OF INVENTION

### Technical Problem

It has been necessary for the conventional radar device exemplified in Patent Literature 1 to provide a time during which a radar signal is not transmitted, and observe electromagnetic noise to suppress a radio wave interference.

An object of the technology of the present disclosure is to provide a radar device that can suppress an interference caused by electromagnetic noise without providing a so-called “radar radiation pause period” during which transmission of a radar signal is stopped to observe electromagnetic noise.

### Solution to Problem

A radar device according to the technology of the present disclosure is a radar device of an FMCW system or a fast chirp system, and includes: a beat signal generator to generate an I-axis local oscillator signal and a Q-axis local oscillator signal from a local oscillator signal that is a real signal, mix the I-axis local oscillator signal and a received signal to generate an I-axis beat signal, and mix the Q-axis local oscillator signal and the received signal to generate a Q-axis beat signal; and a signal processor to perform signal processing on I-axis digital data and Q-axis digital data obtained by sampling the I-axis beat signal and the Q-axis beat signal, and the signal processor generates complex digital data from the I-axis digital data and the Q-axis digital data, performs FFT on the complex digital data, and measures a range and a Doppler velocity of an observation target on a basis of a property that an analytic signal does not have a negative frequency component, wherein the radar device further comprises: an amplitude/phase calculator to perform range FFT on each of the I-axis digital data and the Q-axis digital data; and a cancellation constant calculator to calculate a cancellation constant for canceling a component caused by electromagnetic noise per range bin on a basis of a processing result of the amplitude/phase calculator.

### Advantageous Effects of Invention

A radar device according to the technology of the present disclosure employs the above configuration and, consequently, can suppress an interference caused by electromagnetic noise without providing a radar radiation pause period.

### BRIEF DESCRIPTION OF DRAWINGS

FIG. 1 is a block diagram illustrating components of a radar device according to Embodiment 1.

FIG. 2 is a block diagram illustrating a detailed configuration of a signal processing unit 16 of the radar device according to Embodiment 1.

FIG. 3 is a flowchart illustrating processing steps performed by the signal processing unit 16 of the radar device according to Embodiment 1.

FIG. 4 is a view for describing processing contents performed by the signal processing unit 16 of the radar device according to Embodiment 1.

FIG. 5 is a block diagram illustrating a detailed configuration of a signal processing unit 16 of a radar device according to Embodiment 2.

FIG. 6 is a flowchart illustrating processing steps performed by the signal processing unit 16 of the radar device according to Embodiment 2.

FIG. 7 is a view for describing processing contents performed by the signal processing unit 16 of the radar device according to Embodiment 2.

FIG. 8 is a block diagram illustrating a detailed configuration of a signal processing unit 16 of a radar device according to Embodiment 3.

FIG. 9 is a flowchart illustrating processing steps performed by the signal processing unit 16 of the radar device according to Embodiment 3.

FIG. 10 is a view for describing processing contents performed by the signal processing unit 16 of the radar device according to Embodiment 3.

FIG. 11 is a block diagram illustrating a detailed configuration of a signal processing unit 16 of a radar device according to Embodiment 4.

FIG. 12 is a flowchart illustrating processing steps performed by the signal processing unit 16 of the radar device according to Embodiment 4.

FIG. 13 is a view for describing processing contents performed by the signal processing unit 16 of the radar device according to Embodiment 4.

### DESCRIPTION OF EMBODIMENTS

Names of “◯◯ units” in this description indicate a unit of each component when a radar device according to the technology of the present disclosure is separated into components. That is, the names of “◯◯ units” in this description neither indicate business organization classification such as government offices or companies, or indicate a group of companions of club activities or group activities. Means and methods described in this description are performed by the radar device that is a machine as a subject, and do not intend to be performed by a human being as the subject. That is, the means and the methods described in this description do not correspond to methods that use only an artificial arrangement.

### Embodiment 1

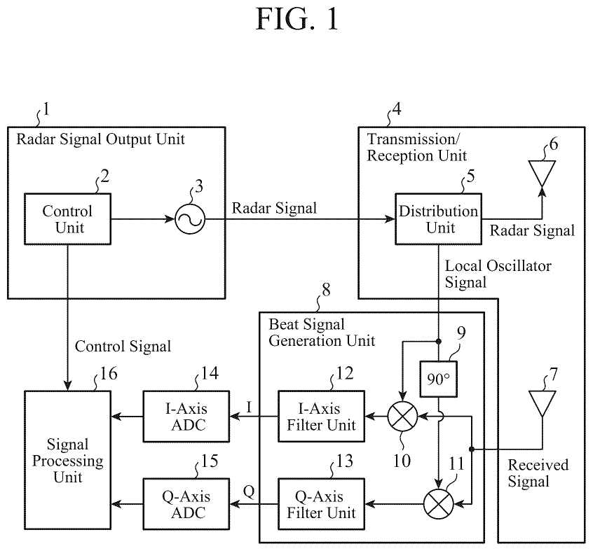

FIG. 1 is a block diagram illustrating components of a radar device according to Embodiment 1. As illustrated in FIG. 1, the radar device according to Embodiment 1 includes a radar signal output unit 1, a transmission/reception unit 4, a beat signal generation unit 8, an I-axis ADC 14, a Q-axis ADC 15, and a signal processing unit 16.

The radar signal output unit 1 includes a control unit 2 and a signal source 3.

The transmission/reception unit 4 includes a distribution unit 5, a transmission antenna 6, and a reception antenna 7.

The beat signal generation unit 8 includes a 90-degree phase shifter 9, an I-axis frequency mixing unit 10, a Q-axis frequency mixing unit 11, an I-axis filter unit 12, and a Q-axis filter unit 13.

The radar device according to Embodiment 1 is connected with each functional block as illustrated in FIG. 1.

### <<Radar Signal Output Unit 1>>

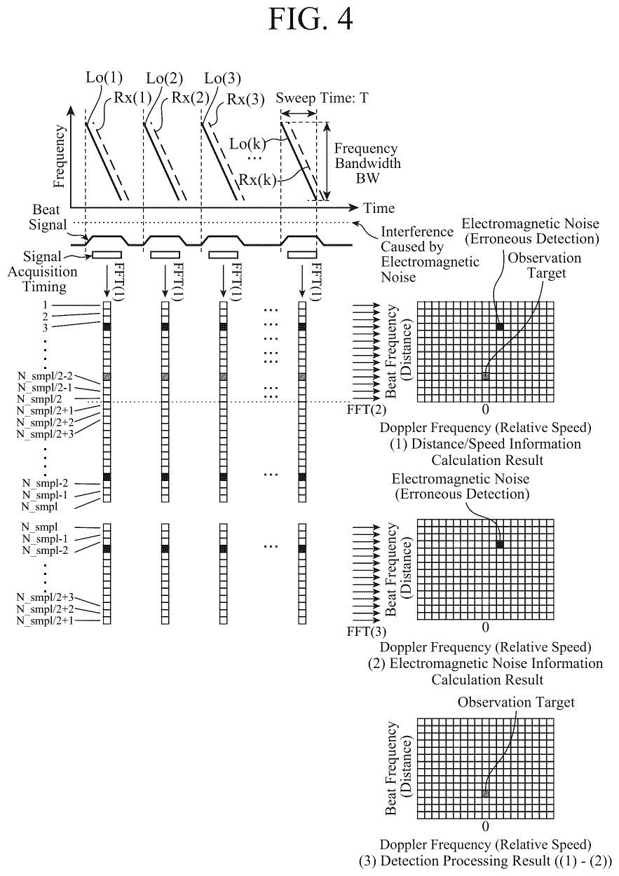

The radar signal output unit 1 is a component that outputs a radar signal. The radar signal output by the radar signal output unit 1 is a signal of a Frequency Modulated-Continuous Wave (FMCW) system or a Fast Chirp Modulation (FCM) system. The fast chirp system performs modulation in an overwhelmingly shorter cycle than a modulation cycle of the FMCW system, and uses only one of modulation to increase a frequency and modulation to decrease the frequency. That is, according to the fast chirp system, one waveform of a transmission wave whose frequency changes in a sawtooth wave shape constitutes one chirp (see, for example, a graph illustrated in an upper part in FIG. 4). According to the fast chirp system, since a modulation cycle is very short, a frequency change caused by a Doppler effect is regarded little to such a degree that the frequency change can be ignored. Furthermore, the fast chirp system can solve an erroneous operation caused by pairing processing of the FMCW system, and therefore is gaining attention in recent years. Either way, the radar device according to the technology of the present disclosure is not a pulse radar, but a Continuous Wave radar (CW radar).

When put in generalized expression, a radar signal output by the radar signal output unit 1 is a frequency modulated signal whose frequency changes as time passes, and is intermittently and repeatedly output. As illustrated in FIG. 1, the radar signal output from the radar signal output unit 1 is sent to the distribution unit 5 of the transmission/reception unit 4.

### <<Control Unit 2 of Radar Signal Output Unit 1>

The control unit 2 of the radar signal output unit 1 is a component that generates a control signal. The control signal generated by the control unit 2 is used to determine, for example, an output timing of the radar signal. As illustrated in FIG. 1, the control signal output from the control unit 2 is sent to the signal source 3 and the signal processing unit 16.

### <<Signal Source 3 of Radar Signal Output Unit 1>

The signal source 3 of the radar signal output unit 1 is a component that is a generation source of radar signals. As described above, the radar signal generated by the signal source 3 is sent to the distribution unit 5 of the transmission/reception unit 4.

### <<Transmission/Reception Unit 4>

The transmission/reception unit 4 is a component that includes a transmission system related to radar signals, and a reception system related to reflection signals from a target that is an observation target. As described above, the transmission/reception unit 4 includes the distribution unit 5, the transmission antenna 6, and the reception antenna 7.

### <<Distribution Unit 5 of Transmission/Reception Unit 4>

The distribution unit 5 of the transmission/reception unit 4 is a component that distributes the radar signal for a transmission signal and for a reference signal. In this description, the radar signal for the transmission signal will be also referred to as a “radar signal”. Furthermore, in this description, the radar signal for the reference signal will be referred to as a “local oscillator signal”.

The radar signal for the transmission signal is sent to the transmission antenna 6.

The radar signal for the reference signal, that is, the local oscillator signal is sent to each of the I-axis frequency mixing unit 10, and the Q-axis frequency mixing unit 11 via the 90-degree phase shifter 9.

### <<Transmission Antenna 6 of Transmission/Reception Unit 4>

The transmission antenna 6 of the transmission/reception unit 4 is an antenna that radiates a radar signal to space such as the atmosphere.

### <<Reception Antenna 7 of Transmission/Reception Unit 4>

The reception antenna 7 of the transmission/reception unit 4 is an antenna that receives a radar signal reflected wave reflected by the observation target. In this description, a signal received by the reception antenna 7 among radar signal reflected waves will be referred to simply as a “received signal”. As illustrated in FIG. 1, the received signal received by the reception antenna 7 is sent to the I-axis frequency mixing unit 10 and the Q-axis frequency mixing unit 11.

### <<Beat Signal Generation Unit 8>

The beat signal generation unit 8 is a component that generates a beat signal. The beat signal is a signal that is generated by mixing the local oscillator signal and the received signal. A beat frequency that is the frequency of the beat signal includes information on a distance to a target and the relative speed of the target. Taking a radar radiation direction into account, the distance to the target is given as a relative position of the target seen from the radar device.

When a radar signal output by the radar signal output unit 1 alternately uses both of an up chirp and a down chirp, information on two of a beat frequency (fᵤₚ) from the up chirp having an increasing FM gradient and a beat frequency (f_{down}) from the down chirp having a decreasing FM gradient is obtained. When the radar signal output by the radar signal output unit 1 is the fast chirp system, one beat frequency is obtained.

One of technical features of the radar device according to the technology of the present disclosure is to perform so-called IQ transform on a beat signal that is a real signal, and generate a complex signal including an I-axis beat signal and a Q-axis beat signal. The I axis (In-Phase Axis) is a so-called in-phase. The Q axis (Quadrature axis) is a quadrature phase. A signal that does not have a negative frequency component among complex signals will be referred to as an analytic signal.

In a technical field of radars, there is known a detection system that is generally called quadrature detection or IQ detection. For quadrature detection, two oscillators of a Local Oscillator (LO) and a Coherent Oscillator (CO) having high frequency stability are used. The received signal is first down-converted into an Intermediate Frequency (IF and hereinafter referred to as an “IF frequency”) range near a difference component using a signal from the local oscillator (corresponding to the signal source 3 according to the technology of the present disclosure), and a mixer (corresponding to the I-axis frequency mixing unit 10 according to the technology of the present disclosure). The down-converted signal then passes a BPF (corresponding to the I-axis filter unit 12 according to the technology of the present disclosure) designed near the IF frequency range via an amplifier. The above operation will be referred to as frequency conversion or heterodyne detection. Subsequently, by mixing (homodyne detection) an in-phase component and a quadrature component of a coherent oscillator, the in-phase component and the quadrature component of the received signal are extracted.

The radar device according to the technology of the present disclosure may perform heterodyne detection and homodyne detection using two oscillators of the Local Oscillator (LO) and the Coherent Oscillator (CO). The technology of the present disclosure acquires not only information on the amplitude but also information on the phase from the received signal converted into a complex signal.

### <<90-Degree Phase Shifter 9 of Beat Signal Generation Unit 8>

The 90-degree phase shifter 9 of the beat signal generation unit 8 is a component that applies a 90-degree phase difference (phase lead or phase delay) from the local oscillator signal. An object to apply the 90-degree phase difference to the local oscillator signal is to generate an analytic signal of the local oscillator signal. When the I axis is put as a real axis on a complex plane and the Q axis is put as an imaginary axis on the complex plane, the phase of the Q axis advances 90 degrees compared to the I axis. For ease of description, the 90-degree phase shifter 9 applies phase lead of 90 degrees in this description. That is, the 90-degree phase shifter 9 receives an input of a local oscillator signal of the I axis (hereinafter, referred to as an “I-axis local oscillator signal”), and outputs a local oscillator signal of the Q axis (hereinafter, referred to as a “Q-axis local oscillator signal”). The 90-degree phase shifter 9 may be implemented as a Hilbert filter.

An angular frequency of a chirp signal changes as time passes, and therefore it is difficult to imagine an operation of “advancing the phase 90 degrees”. The chirp signal can be expressed as, for example, a complex number as follows.

$${g}_{chirp} ( t ) := {Ae}^{jh ( t )} \qquad ( 1 )$$

$$wherein$$

$$\frac{dh ( t )}{dt} = at + {ω}_{0}$$

Here, “j” represents an imaginary number unit, and “A” represents the amplitude of the chirp signal.

A real part of g_{chirp}(t) indicated in the equation (1) can be considered as a real signal and a local oscillator signal. “Applying 90-degree phase lead” intended by the technology of the present disclosure is to generate an imaginary part of g_{chirp}(t) from the real part of g_{chirp}(t) by using the expression of the complex number.

Note that whether the 90-degree phase shifter 9 applies 90-degree phase lead or applies 90-degree phase delay to a local oscillator signal is not essential.

The radar device according to the technology of the present disclosure may create an I-axis signal by putting the local oscillator signal that is the real signal as the Q axis and using the 90-degree phase shifter 9. When the 90-degree phase shifter 9 applies the 90-degree phase delay, an input to the 90-degree phase shifter 9 is the Q-axis local oscillator signal, and an output of the 90-degree phase shifter 9 is the I-axis local oscillator signal.

### <<I-Axis Frequency Mixing Unit 10 of Beat Signal Generation Unit 8>

The I-axis frequency mixing unit 10 of the beat signal generation unit 8 is a component that mixes the local oscillator signal and the received signal. The I-axis frequency mixing unit 10 generates the I-axis beat signal.

The I-axis beat signal generated by the I-axis frequency mixing unit 10 is sent to the I-axis filter unit 12.

### <<Q-Axis Frequency Mixing Unit 11 of Beat Signal Generation Unit 8>

The Q-axis frequency mixing unit 11 of the beat signal generation unit 8 is a component that mixes the local oscillator signal whose phase has been delayed by 90 degrees, and the received signal. The Q-axis frequency mixing unit 11 generates the Q-axis beat signal.

The Q-axis beat signal generated by the Q-axis frequency mixing unit 11 is sent to the Q-axis filter unit 13.

### <<I-Axis Frequency Filter Unit 12 of Beat Signal Generation Unit 8>

The I-axis filter unit 12 of the beat signal generation unit 8 is a filter for the I-axis beat signal. The I-axis filter unit 12 is more specifically a Low Pass Filter (LPF) or a Band Pass Filter (BPF). The I-axis filter unit 12 is used to suppress an unnecessary component such as a spurious from an I-axis beat signal just generated by the I-axis frequency mixing unit 10. The spurious is a frequency component that mainly has a high frequency, is included in an alternating current signal, and is not intended in terms of design.

### <<Q-Axis Filter Unit 13 of Beat Signal Generation Unit 8>>

The Q-axis filter unit 13 of the beat signal generation unit 8 is a filter for the Q-axis beat signal. The Q-axis filter unit 13 is more specifically a Low Pass Filter (LPF) or a Band Pass Filter (BPF) similarly to the I-axis filter unit 12. The Q-axis filter unit 13 is used to suppress an unnecessary component such as a spurious from a Q-axis beat signal just generated by the Q-axis frequency mixing unit 11.

### <<I-Axis ADC 14 and Q-Axis ADC 15>>

The I-axis ADC 14 and the Q-axis ADC 15 are more specifically analog-to-digital converters.

The I-axis ADC 14 converts an I-axis beat signal that is an analog signal into I-axis digital data. The I-axis digital data is expressed as follows.

$$l := \{ \begin{matrix}{i}_{1} , & {i}_{2} , & … , & {i}_{k} , & …\end{matrix} \} wherein {}^{∀} k , {i}_{k} ∈ ℝ \qquad ( 2 )$$

Here, iₖ is expressed as a real number in the equation (2), yet, strictly speaking, is a quantized real number such as a double type or a float type. k in the equation (2) is a sampling number, and takes an integer from 1 to N_ₛₘₚₗ.

The Q-axis ADC 15 converts a Q-axis beat signal that is an analog signal into Q-axis digital data. The Q-axis digital data is expressed as follows.

$$Q := \{ \begin{matrix}{q}_{1} , & {q}_{2} , & … , & {q}_{k} , & …\end{matrix} \} wherein {}^{∀} k , {q}_{k} ∈ ℝ \qquad ( 3 )$$

Here, qₖ is expressed as a real number in the equation (3), yet, strictly speaking, is a quantized real number such as the double type or the float type. k in the equation (3) is also a sampling number.

The I-axis digital data and the Q-axis digital data will be collectively referred to as IQ data. The IQ data is sent to the signal processing unit 16.

### <<Signal Processing Unit 16>

The signal processing unit 16 is a component that performs signal processing for calculating a distance to a target and a relative speed of the target.

By referring to a control signal sent from the control unit 2, the signal processing unit 16 can specify a period during which the radar signal output unit 1 outputs a radar signal. In this description, the period specified as the period during which the radar signal output unit 1 outputs the radar signal will be referred to as a “specific period”.

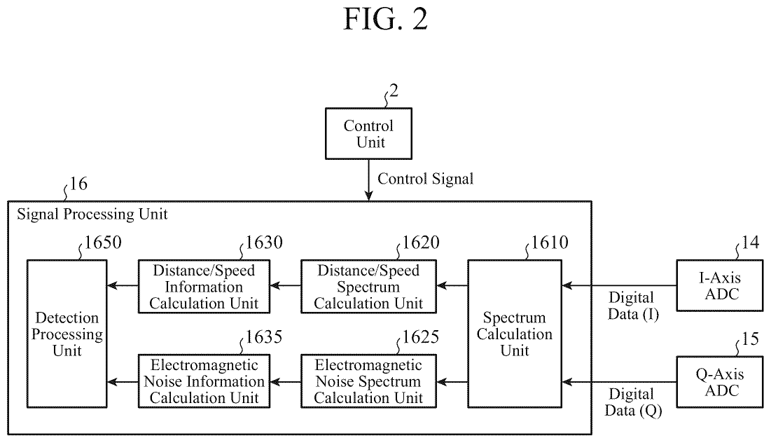

FIG. 2 is a block diagram illustrating a detailed configuration of the signal processing unit 16 of the radar device according to Embodiment 1.

As illustrated in FIG. 2, the signal processing unit 16 of the radar device according to Embodiment 1 includes a spectrum calculation unit 1610, a distance/speed spectrum calculation unit 1620, an electromagnetic noise spectrum calculation unit 1625, a distance/speed information calculation unit 1630, an electromagnetic noise information calculation unit 1635, and a detection processing unit 1650.

The signal processing unit 16 of the radar device according to Embodiment 1 is connected with each functional block as illustrated in FIG. 2.

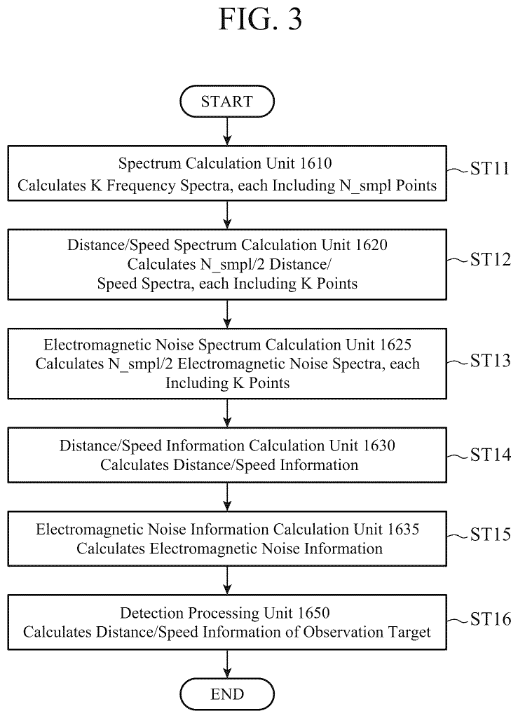

FIG. 3 is a flowchart illustrating processing steps performed by the signal processing unit 16 of the radar device according to Embodiment 1. As illustrated in FIG. 3, the processing steps performed by the signal processing unit 16 include ST11, ST12, ST13, ST14, ST15, and ST16. Details of the respective processing steps will be made more apparent from description to be described later.

### <<Spectrum Calculation Unit 1610 of Signal Processing Unit 16>

The spectrum calculation unit 1610 of the signal processing unit 16 is a component that performs Fourier transform (hereinafter, referred to as “range Fourier transform”) in a distance direction, and calculates a frequency spectrum (ST11 illustrated in FIG. 3). The range Fourier transform is Fourier transform to be performed at the first time, and will be also referred to as first Fourier transform.

The spectrum calculation unit 1610 creates complex digital data given as follows using digital data during the specific period.

$$\{ \begin{matrix}{\overbrace{{i}_{1} + {jq}_{1}}}^{{c}_{1}} , & {\overbrace{{i}_{2} + {jq}_{2}}}^{{c}_{2}} , & … , & {\overbrace{{i}_{k} + {jq}_{k}}}^{{c}_{k}} , & …\end{matrix} \} {}^{∀} k , {i}_{k} + {jq}_{k} \text{=:} {c}_{k} ∈ ℂ \qquad ( 4 )$$

k in the equation (4) is also a sampling number.

More specifically, the spectrum calculation unit 1610 performs range Fourier transform on the complex digital data expressed in the equation (4). A result obtained by the range Fourier transform will be referred to as a frequency spectrum.

Data obtained by the result of the range Fourier transform is data of a complex number in the frequency domain. In an ideal case where there is no noise, a frequency that comes to a peak in the frequency domain is a beat frequency. Although the peak (spectrum peak) in the frequency domain is also a complex number, a Doppler frequency can be calculated from phase information of this spectrum peak. To calculate the Doppler frequency from the phase information of the spectrum peak, Doppler Fourier transform to be described later is performed.

Although a beat signal is repeatedly generated, the spectrum calculation unit 1610 performs range Fourier transform every time.

A plurality of frequency spectra calculated by the spectrum calculation unit 1610 is sent to the distance/speed spectrum calculation unit 1620 and the electromagnetic noise spectrum calculation unit 1625.

### <<Distance/Speed Spectrum Calculation Unit 1620 of Signal Processing Unit 16>>

The distance/speed spectrum calculation unit 1620 of the signal processing unit 16 is a component that performs Fourier transform (hereinafter, referred to as “Doppler Fourier transform”) in a relative speed direction, and calculates a distance/speed spectrum (ST12 illustrated in FIG. 3). The Doppler Fourier transform is Fourier transform to be performed at the second time, and will be also referred to as second Fourier transform.

The distance/speed spectrum calculation unit 1620 performs Doppler Fourier transform on a positive frequency domain (hereinafter, referred to as “positive domain frequency spectrum data”) of frequency spectrum data. That is, a result obtained by performing Doppler Fourier transform on the positive domain frequency spectrum data will be referred to as a distance/speed spectrum.

By the way, Fast Fourier Transform will be referred to as FFT. The radar device according to the technology of the present disclosure performs range Fourier transform and Doppler Fourier transform in a mode of range FFT and Doppler FFT. An operation of performing both of range FFT and Doppler FFT will be also referred to as two-dimensional FFT since information to be obtained is two-dimensional (see FIGS. 4, 7, 10).

As illustrated in FIG. 2, the distance/speed spectrum is sent to the distance/speed information calculation unit 1630.

### <<Electromagnetic Noise Spectrum Calculation Unit 1625 of Signal Processing Unit 16>>

The electromagnetic noise spectrum calculation unit 1625 of the signal processing unit 16 is a component that performs Doppler Fourier transform, and calculates an electromagnetic noise spectrum (ST13 illustrated in FIG. 3).

The electromagnetic noise spectrum calculation unit 1625 performs Doppler Fourier transform on a negative frequency domain (hereinafter, referred to as “negative domain frequency spectrum data”) of frequency spectrum data. That is, a result obtained by performing Doppler Fourier transform on the negative domain frequency spectrum data will be referred to as an electromagnetic noise spectrum.

As illustrated in FIG. 2, the electromagnetic noise spectrum is sent to the electromagnetic noise information calculation unit 1635.

### <<Distance/Speed Information Calculation Unit 1630 of Signal Processing Unit 16>>

The distance/speed information calculation unit 1630 of the signal processing unit 16 is a component that calculates a distance to a target and a relative speed of the target on the basis of the distance/speed spectrum (ST14 illustrated in FIG. 3).

More specifically, the distance/speed information calculation unit 1630 detects a peak value of the distance/speed spectrum, and calculates a beat frequency and a Doppler frequency on the basis of the peak value. The beat frequency gives the distance to the target, and the Doppler frequency gives the Doppler velocity of the target.

Information on the beat frequency and the Doppler frequency calculated by the distance/speed information calculation unit 1630 or information on the distance to the target or the Doppler velocity of the target is sent to the detection processing unit 1650.

### <<Electromagnetic Noise Information Calculation Unit 1635 of Signal Processing Unit 16>>

The electromagnetic noise information calculation unit 1635 of the signal processing unit 16 is a component that calculates a frequency and a Doppler frequency derived from electromagnetic noise on the basis of the electromagnetic noise spectrum (ST15 illustrated in FIG. 3).

More specifically, the electromagnetic noise information calculation unit 1635 detects a peak value of the electromagnetic noise spectrum, and calculates the frequency and the Doppler frequency derived from the electromagnetic noise on the basis of the peak value.

Information on the frequency and the Doppler frequency derived from the electromagnetic noise calculated by the electromagnetic noise information calculation unit 1635 is sent to the detection processing unit 1650.

### <<Detection Processing Unit 1650 of Signal Processing Unit 16>>

The detection processing unit 1650 of the signal processing unit 16 is a component that suppresses an influence of the electromagnetic noise, and detects a likely relative position and relative speed related to the target (ST16 illustrated in FIG. 3). As illustrated in FIG. 2, the processing performed by the detection processing unit 1650 is performed on the basis of the information sent from the distance/speed information calculation unit 1630 and the information sent from the electromagnetic noise information calculation unit 1635.

FIG. 4 is a view for describing processing contents performed by the signal processing unit 16 of the radar device according to Embodiment 1.

In a graph illustrated in the upper part in FIG. 4, {L_{O}(1), L_{O}(2), . . . , and L_{O}(K)} are local oscillator signals. In the graph illustrated in the upper part in FIG. 4, the horizontal axis indicates a time, and the vertical axis indicates a frequency. In FIG. 4, down chirps are exemplified as local oscillator signals. A sweep time of one chirp signal is represented by “T”, and is at an order of s (microseconds). The frequency band of the chirp signal is represented by “BW”.

In the graph illustrated in the upper part in FIG. 4, {R_{X}(1), R_{X}(2), . . . , and R_{X}(K)} are received signals.

“K” in FIG. 4 represents a chirp number for identifying what number a chirp signal is.

The graph illustrated in the upper part in FIG. 4 shows electromagnetic noise indicated by broken lines. This description assumes for ease of description that electromagnetic noise is a continuous wave of a constant frequency. Furthermore, the electromagnetic noise directly enters the I-axis ADC 14 and the Q-axis ADC 15. Furthermore, electromagnetic noise that enters the I-axis ADC 14 and electromagnetic noise that enters the Q-axis ADC 15 are not correlated with each other. Generally, the I-axis ADC 14 and the Q-axis ADC 15 are disposed at different locations on a substrate, so that it is possible to assume that entering noises are not correlated.

A plurality of rectangles with description “signal acquisition timing” in FIG. 4 are periods in the above-described specific period, and are periods during which a beat frequency can be acquired. The signal processing unit 16 acquires a signal at this signal acquisition timing.

Three lattice-pattern graphs illustrated in a right column in FIG. 4 are graphs showing results of the above-described two-dimensional FFT. In this description, the lattice-pattern graphs showing the results of two-dimensional FFT will be referred to as “two-dimensional FFT lattice diagrams”.

In the two-dimensional FFT lattice diagrams illustrated in FIG. 4, the vertical axis indicates a beat frequency (distance), and the horizontal axis indicates a Doppler frequency (relative speed). Note that there is also a graph that shows a two-dimensional FFT result, and whose horizontal axis indicates the beat frequency and whose vertical axis indicates the Doppler frequency.

Taking simplification of description into account, a portion corresponding to an observation target (target) and a portion corresponding to electromagnetic noise (erroneous detection) are blacked one by one in the two-dimensional FFT lattice diagram exemplified in FIG. 4.

Portions indicated as “FFT(1)” in FIG. 4 indicate range FFT. A beat frequency (F_{sb_r}) that can be acquired by range FFT satisfies a following relational expression.

$${F}_{sb \_ r} = \frac{2 R \cdot Δ f}{c \cdot T} \qquad ( 5 )$$

Here, “Δf” represents a frequency difference (also referred to as a “maximum frequency deviation range”) between an upper limit and a lower limit of the frequency band (BW), “R” represents a range, “c” represents a light speed, and “T” represents a sweep time (or a chirp cycle). Furthermore, it is assumed in the equation (5) that a modulation cycle is very short, and a term related to the Doppler frequency is not described. Note that, in a subscript sb_r of “F_{sb_r}”, “sb” represents first letters of signal beat, and “r” represents an initial letter of range.

Below portions indicated as “FFT(1)” in FIG. 4, vertically long rectangles whose sizes are N_ₛₘₚₗ×1 are illustrated. The respective rectangles include three blacked portions. The blacked portions indicate peak positions of the frequency spectrum. That is, there are three frequency spectrum peaks in the example in FIG. 4.

In each rectangle, the second portion from the top among the blacked portions indicates a position corresponding to the beat frequency (F_{sb_r}) indicated in the equation (5).

As described above, the analytic signal does not have a negative frequency component. Furthermore, a complex signal related to an ideal beat signal including no noise is an analytic signal.

In the vertically long rectangle illustrated in FIG. 4, an upper half (numbers 1 to N_ₛₘₚₗ/2) indicates a positive frequency domain. Furthermore, in the vertically long rectangle, a lower half (numbers (N_ₛₘₚₗ/2)+1 to N_smpl) indicates a negative frequency domain. Furthermore, a middle position of the rectangle indicated by a broken line is a position at which the beat frequency is 0. While sampling numbers 1 to N_ₛₘₚₗ are assigned in order of a lapse of time in the time domain, numbers 1 to N_ₛₘₚₗ are assigned in a direction from a higher positive frequency to a negative frequency in the frequency domain.

A fourth position above from the middle of the rectangle is blacked and indicated, and intends a spectrum peak that derives from a reflected wave caused only by a target. The spectrum peak that derives from the reflected wave caused only by the target appears as a frequency analysis result of the analytic signal, and therefore does not have the negative frequency component. Hence, in FIG. 4, although the fourth position above from the middle of the rectangle is blacked, the fourth position below from the middle of the rectangle is not blacked. This means that, according to the procedure or the method according to the technology of the present disclosure, a signal reflected by the target does not have a spectrum peak in the negative frequency domain.

When Fourier transform is performed on not a complex signal but a real signal, spectrum peaks symmetrically appear not only in the positive frequency domain, but also in the negative frequency domain. Hence, when, for example, electromagnetic noise enters one of the I-axis ADC 14 and the Q-axis ADC 15, the spectrum peaks appear in both of the positive frequency domain and the negative frequency domain by performing Fourier transform on this electromagnetic noise signal.

In the vertically long rectangle illustrated in FIG. 4, an uppermost peak and a lowermost peak at the symmetrical positions indicate spectrum peaks caused by the electromagnetic noise.

In the example illustrated in FIG. 4, beat signals are acquired at K signal acquisition timings for K continuous chirp signals, and are subjected to range FFT K times.

Portions indicated as “FFT(2)” in FIG. 4 indicate Doppler FFT performed by the distance/speed spectrum calculation unit 1620. A Doppler frequency (F_{sb_v}) that can be acquired by Doppler FFT satisfies a following relational expression.

$${F}_{sb \_ v} = \frac{2 f \cdot v}{c} \qquad ( 6 )$$

Here, “f” represents the center frequency of a local oscillator signal, and “v” represents a relative speed of a target seen from the radar device. Note that, strictly speaking, “v” represents a speed component in a radar radiation direction in the relative speed of the target seen from the radar device. Generally, a speed component that produces a Doppler effect in a speed of a certain object is referred to as a Doppler velocity. Accordingly, “v” in the equation (6) represents the Doppler velocity of the target. Note that, in a subscript sb_v of “F_{sb_v}”, “sb” represents first letters of signal beat, and “v” represents velocity.

The top two-dimensional FFT lattice diagram among the two-dimensional FFT lattice diagrams exemplified in FIG. 4 indicates a result of Doppler FFT performed by the distance/speed spectrum calculation unit 1620. This two-dimensional FFT lattice diagram exemplifies the Doppler frequency of the observation target (i.e., target) as 0, and, moreover, the Doppler frequency of the electromagnetic noise (erroneous detection) is exemplified as a value corresponding to a second square to the right seen from 0.

A portion indicated as “FFT(3)” in FIG. 4 indicates Doppler FFT performed by the electromagnetic noise spectrum calculation unit 1625. As exemplified in FIG. 4, the electromagnetic noise spectrum calculation unit 1625 performs processing of inverting to a positive sign a sign of data related to the negative frequency domain obtained by range FFT, and then perform Doppler FFT on the data.

The second two-dimensional FFT lattice diagram among the two-dimensional FFT lattice diagrams exemplified in FIG. 4 from the top indicates a result of Doppler FFT performed by the electromagnetic noise spectrum calculation unit 1625. This two-dimensional FFT lattice diagram also exemplifies the Doppler frequency of the electromagnetic noise (i.e., erroneous detection) as a value corresponding to the second square to the right seen from 0.

The third two-dimensional FFT lattice diagram among the two-dimensional FFT lattice diagrams exemplified in FIG. 4 from the top can be obtained by subtracting the second two-dimensional FFT lattice diagram from the top two-dimensional FFT lattice diagram. The third two-dimensional FFT lattice diagram from the top indicates information obtained by a processing result of the detection processing unit 1650.

One of the technical features of the radar device according to Embodiment 1 is that the radar device according to Embodiment 1 includes the 90-degree phase shifter 9 that applies a 90-degree phase difference (phase lead or phase delay) to a local oscillator signal. According to this configuration, the radar device according to Embodiment 1 generates an I-axis beat signal and a Q-axis beat signal.

From another viewpoint, the technical features of the radar device according to Embodiment 1 include performing signal processing by applying a principal that “an analytic signal does not have the negative frequency component”.

As described above, the radar device according to Embodiment 1 provides an effect that a radar radiation pause period for observing only electromagnetic noise is unnecessary.

### Embodiment 2

A radar device according to Embodiment 2 is a modification example of the radar device according to the technology of the present disclosure. Unless clearly indicated in particular, the same reference numerals as those in Embodiment 1 will be used in Embodiment 2. Furthermore, Embodiment 2 will omit description that overlaps those in Embodiment 1 as appropriate.

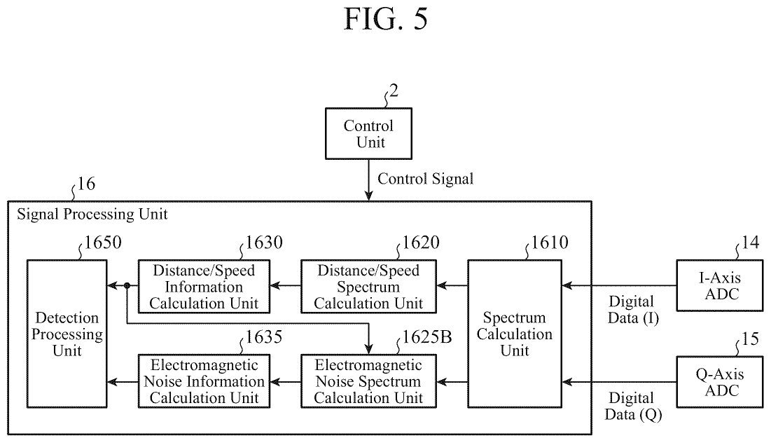

FIG. 5 is a block diagram illustrating a detailed configuration of a signal processing unit 16 of the radar device according to Embodiment 2.

Upon comparison between FIG. 5 and FIG. 2 (Embodiment 1), the signal processing unit 16 according to Embodiment 2 includes as a component an electromagnetic noise spectrum calculation unit 1625B in place of the electromagnetic noise spectrum calculation unit 1625. The electromagnetic noise spectrum calculation unit 1625B receives an input of information from the distance/speed information calculation unit 1630.

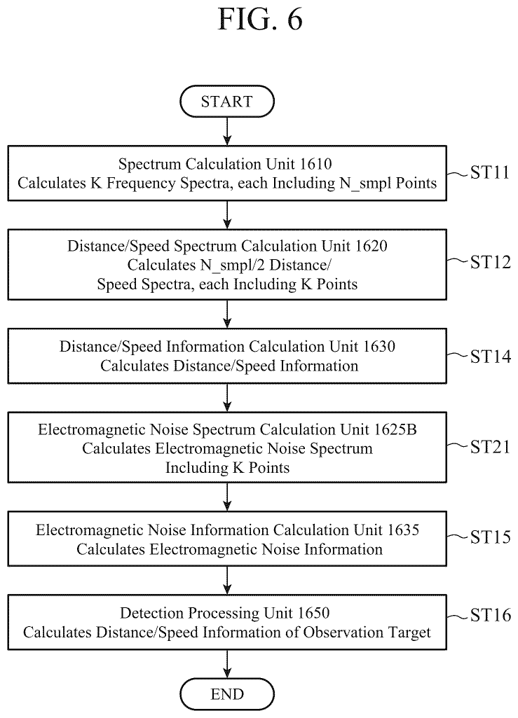

FIG. 6 is a flowchart illustrating processing steps performed by the signal processing unit 16 of the radar device according to Embodiment 2.

Upon comparison between FIG. 6 and FIG. 3 (Embodiment 1), the signal processing unit 16 according to Embodiment 2 performs ST21 instead of ST13 after ST14.

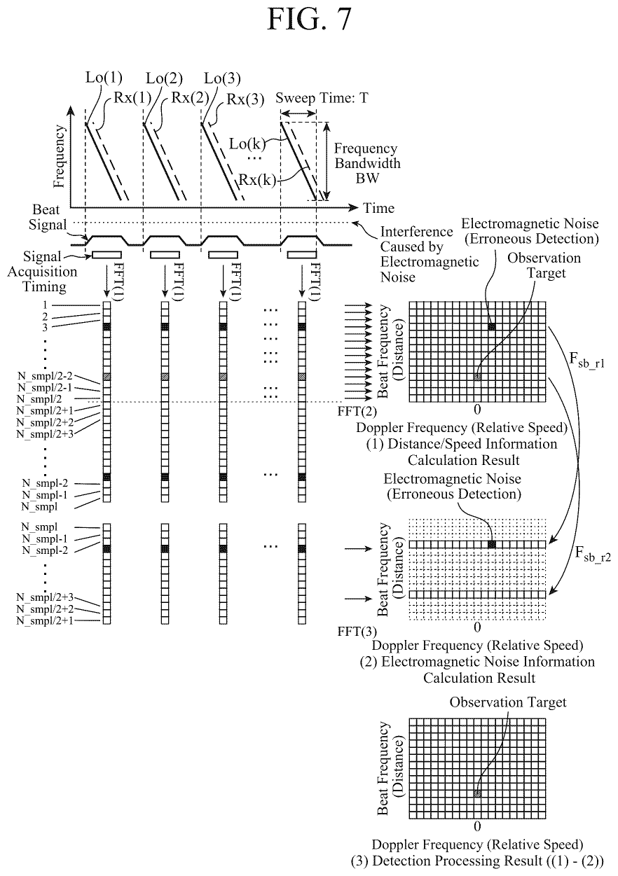

FIG. 7 is a view for describing processing contents performed by the signal processing unit 16 of the radar device according to Embodiment 2.

Upon comparison between FIG. 7 and FIG. 4 (Embodiment 1), the electromagnetic noise spectrum calculation unit 1625B according to Embodiment 2 performs Doppler FFT not on the entire negative frequency domain, but only on specific data including a spectrum peak. The specific data including the spectrum peak is more specifically data related to a negative beat frequency corresponding to the beat frequency of the spectrum peak produced in the positive frequency domain.

In a case exemplified in FIG. 7, the beat frequency of the spectrum peak produced in the positive frequency domain is the fourth square above from the center and the 11th square above from the center. Accordingly, the electromagnetic noise spectrum calculation unit 1625B performs processing of inverting to a positive sign a sign of data related to the negative frequency domain obtained by range FFT, and then performs Doppler FFT only on the fourth square above from the origin and the 11th square above from the center. That is, the electromagnetic noise spectrum calculation unit 1625B according to Embodiment 2 performs Doppler FFT on a necessary range in a limited manner (ST21 illustrated in FIG. 6).

In addition to the technical features of the radar device according to Embodiment 1, technical features of the radar device according to Embodiment 2 include that the electromagnetic noise spectrum calculation unit 1625B performs Doppler FFT on a necessary range in a limited manner.

As described above, the radar device according to Embodiment 2 provides an effect that it is possible to minimize the number of times of Doppler FFT to be performed in addition to the effect described in Embodiment 1.

### Embodiment 3

A radar device according to Embodiment 3 is a modification example of the radar device according to the technology of the present disclosure. Unless clearly indicated in particular, the same reference numerals as those in the existing embodiments will be used in Embodiment 3. Furthermore, Embodiment 3 will omit description that overlaps those in the existing embodiments as appropriate.

To simply put, technical features unique to the radar device according to Embodiment 3 include determining whether or not an I-axis beat signal and a Q-axis beat signal that have been actually sampled and measured are a real part and an imaginary part of an ideal analytic signal.

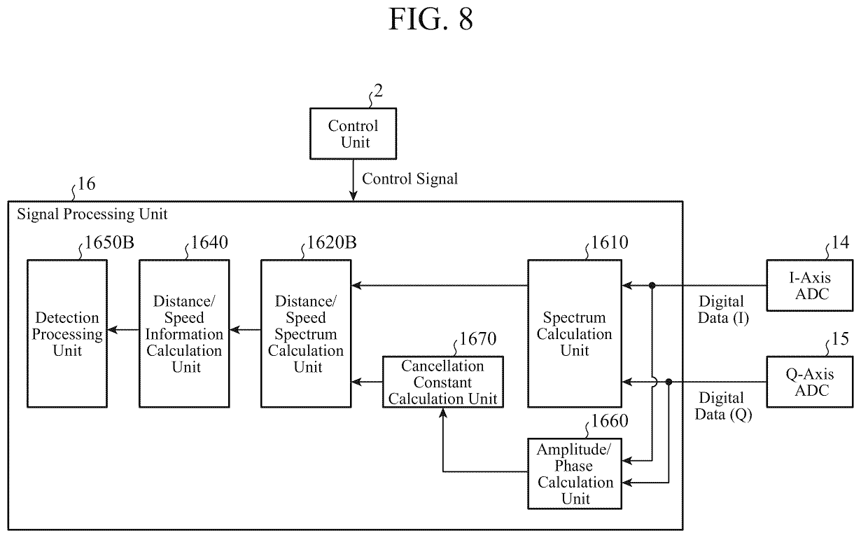

FIG. 8 is a block diagram illustrating a detailed configuration of a signal processing unit 16 of the radar device according to Embodiment 3.

As illustrated in FIG. 8, the signal processing unit 16 of the radar device according to Embodiment 3 includes the spectrum calculation unit 1610, a distance/speed spectrum calculation unit 1620B, a distance/speed information calculation unit 1640, a detection processing unit 1650B, an amplitude/phase calculation unit 1660, and a cancellation constant calculation unit 1670.

The signal processing unit 16 of the radar device according to Embodiment 3 is connected with each functional block as illustrated in FIG. 8.

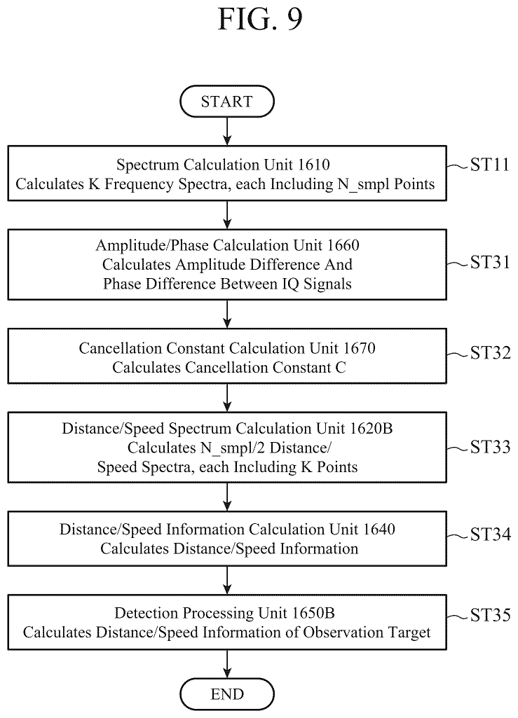

FIG. 9 is a flowchart illustrating processing steps performed by the signal processing unit 16 of the radar device according to Embodiment 3. As illustrated in FIG. 9, the processing steps performed by the signal processing unit 16 according to Embodiment 3 include ST11, ST31, ST32, ST33, ST34, and ST35. Details of the respective processing steps will be made more apparent from description to be described later.

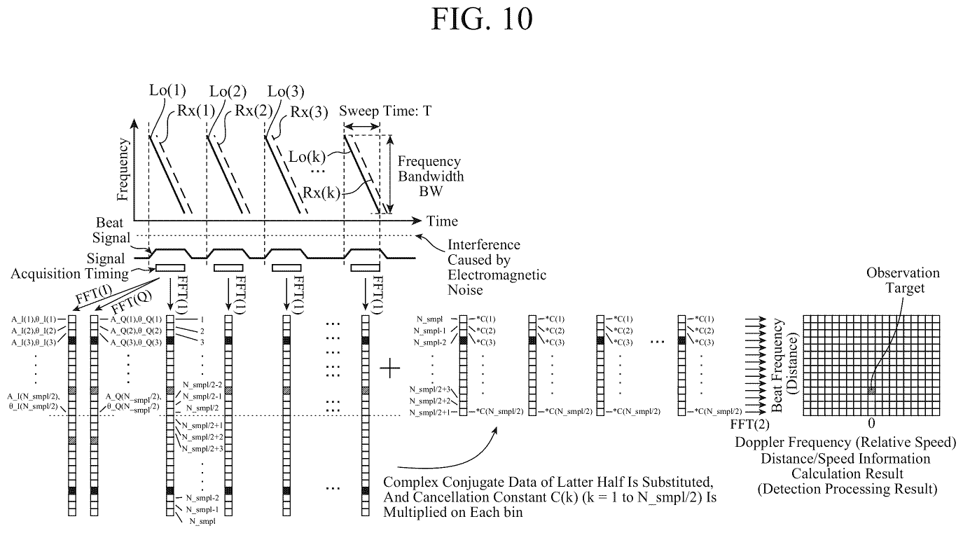

FIG. 10 is a view for describing processing contents performed by the signal processing unit 16 of the radar device according to Embodiment 3. As illustrated in FIG. 10, the signal processing unit 16 of the radar device according to Embodiment 3 performs range FFT (indicated as “FFT(I)” in FIG. 10) only on the I-axis beat signal, and range FFT (indicated as “FFT(Q)” in FIG. 10) only on the Q-axis beat signal.

### <<Amplitude/Phase Calculation Unit 1660 of Signal Processing Unit 16>>

The amplitude/phase calculation unit 1660 of the signal processing unit 16 is a component that performs range FFT on each of the I-axis beat signal and the Q-axis beat signal, and calculates an amplitude ratio and a phase difference per range bin.

A result of range FFT performed on the I-axis beat signal is expressed as follows, for example.

$$ℱ [ \{ \begin{matrix}{i}_{1} , & {i}_{2} , & … , & {i}_{N \_ smpl}\end{matrix} \} ] \text{=:} \{ \begin{matrix}{I}_{1} , & {I}_{2} , & … , & {I}_{N \_ smpl}\end{matrix} \} \qquad ( 7 )$$

$$wherein {}^{∀} k , {I}_{k} ∈ ℂ$$

Here, “F” in the script font represents an operation of Fourier transform. Furthermore, as described above, on the left side of the equation (7) that is the time domain, sampling numbers 1 to N_ₛₘₚₗ are assigned in order of a lapse of time. On the other hand, on the right side of the equation (7) that is the frequency domain, numbers 1 to N_ₛₘₚₗ are assigned in a direction from +∞ to −∞ of the frequency. The numbers 1 to N_ₛₘₚₗ in the frequency domain are also numbers for identifying range bins.

Similarly, a result of range FFT performed on the Q-axis beat signal is also expressed as follows.

$$ℱ [ \{ \begin{matrix}{q}_{1} , & {q}_{2} , & … , & {q}_{N \_ smpl}\end{matrix} \} ] \text{=:} \{ \begin{matrix}{Q}_{1} , & {Q}_{2} , & … , & {Q}_{N \_ smpl}\end{matrix} \} \qquad ( 8 )$$

$$wherein {}^{∀} k , {Q}_{k} ∈ ℂ$$

The amplitude ratio and the phase difference of each range bin calculated by the amplitude/phase calculation unit 1660 are expressed as follows.

$$[ \begin{matrix}\frac{\vert I \vert}{\vert Q \vert} \\ ∠ I - ∠ Q\end{matrix} ] = \{ \begin{matrix}\frac{\vert {I}_{1} \vert}{\vert {Q}_{1} \vert} & \frac{\vert {I}_{2} \vert}{\vert {Q}_{2} \vert} & … , & \frac{\vert {I}_{N \_ smpl} \vert}{\vert {Q}_{N \_ smpl} \vert} \\ ∠ {I}_{1} - ∠ {Q}_{1} & ∠ {I}_{2} - ∠ {Q}_{2} & … , & ∠ {I}_{N \_ smpl} - ∠ {Q}_{N \_ smpl}\end{matrix} \} \qquad ( 9 )$$

The equation (9) expresses the amplitude ratio and the phase difference of the I-axis beat signal seen from the Q-axis beat signal. A symbol of an absolute value appearing in the equation (9) indicates the magnitude of a complex number (a distance from the origin on the complex plane). Furthermore, a symbol indicating an angle appearing in the equation (9) indicates an amplitude of the complex number. Note that, in FIG. 10, the magnitude of the complex number is expressed as “A_”, and the amplitude of the complex number is expressed as “0”. Furthermore, although arrows are indicated in such a way that the amplitude ratio and the phase difference of each range bin are calculated at a first signal acquisition timing in the example in FIG. 10, the technology of the present disclosure is not limited thereto. The amplitude/phase calculation unit 1660 according to Embodiment 3 statistically performs calculation (obtains, for example, an average value or a median value) on the basis of information obtained from a plurality of beat signals, and obtain the amplitude ratio and the phase difference of each range bin.

If the I-axis beat signal and the Q-axis beat signal that have been actually sampled and measured are a real part and an imaginary part of an ideal analytic signal, the amplitude ratios of all range bins are 1, and the phase differences of all range bins are −90 degrees as for the amplitude ratio and the phase difference of each range bin expressed in the equation (9).

The amplitude ratio and the phase difference of each range bin are sent to the cancellation constant calculation unit 1670.

### <<Cancellation Constant Calculation Unit 1670 of Signal Processing Unit 16>>

The cancellation constant calculation unit 1670 of the signal processing unit 16 is a component that calculates a cancellation constant (weight) for canceling a component caused by electromagnetic noise per range bin.

Determination on whether or not the I-axis beat signal and the Q-axis beat signal that have been actually sampled and measured are a real part and an imaginary part of an ideal analytic signal can be confirmed according to, for example, a following equation.

$$for k = 1 to \frac{{N}_{\_ smpl}}{2} \qquad ( 10 )$$

$${W}_{k} ≡ \{ \begin{matrix}0 , & if {‖ {I}_{k} - ( - j ) {Q}_{k} ‖}_{2} < ε \\ 1 , & else\end{matrix}$$

Here, ε (epsilon) appearing in the equation (10) is a threshold for determining to what degree an error is permitted. Wₖ given by the equation (10) is a cancellation constant (weight) for canceling a component caused by electromagnetic noise. For ease of description, this description assumes that N_ₛₘₚₗ is an even number. When the I-axis beat signal and the Q-axis beat signal that have been actually sampled and measured are close to the real part and the imaginary part of the ideal analytic signal, a conditional expression of a norm given by the right side of the equation (10) is satisfied, and Wₖ is 0. By contrast with this, when the I-axis beat signal and the Q-axis beat signal that have been actually sampled and measured are far from the real part and the imaginary part of the ideal analytic signal, the conditional expression of the norm given by the right side of the equation (10) is not satisfied, and Wₖ is 1.

To simply put, the conditional expression of the norm expressed in the equation (10) compares Iₖ multiplied with −j and Qₖ multiplied with −j. Multiplying Qₖ with −j is equivalent to delaying the phase of Qₖ by 90 degrees, and converting Qₖ into such a form that Qₖ can be compared with original Iₖ.

The meaning of the equation (10) becomes clear by applying the ideal analytic signal exemplified below.

$${e}^{j {ω}_{0} t} = cos ( {ω}_{0} t ) \text{?} + j sin ( {ω}_{0} t ) \text{?} \qquad ( 11 )$$

$$\text{?} \text{indicates text missing or illegible when filed}$$

When the ideal analytic signal expressed in the equation (11) is subjected to Fourier transform using cos(ω₀t) as a fundamental wave, and when the angular frequency is ω₀, the I axis is 1+0j and the Q axis is 0+j. Then, in a case where a kth range in the equation (10) corresponds to ω₀, the conditional expression of the norm given by the right side of the equation (10) is calculated as follows.

$$\begin{matrix}{‖ {I}_{k} - ( - j ) {Q}_{k} ‖}_{2} = {‖ ( 1 + 0 j ) \text{?} - ( - j ) ( 0 + j ) \text{?} ‖}_{2} \\ = {‖ 1 - 1 ‖}_{2} \\ = 0\end{matrix} \qquad ( 12 )$$

$$\text{?} \text{indicates text missing or illegible when filed}$$

As described above, in a case of the ideal analytic signal, the conditional expression of the norm given by the right side of the equation (10) is satisfied.

The cancellation constant (weight and Wₖ) calculated by the cancellation constant calculation unit 1670 does not need to take a “binary value of 0 or 1” as expressed in the equation (10). The cancellation constant (weight and Wₖ) calculated by the cancellation constant calculation unit 1670 may take a value other than the binary value as expressed in, for example, the following equation.

$$for k = 1 to \frac{{N}_{\_ smpl}}{2} \qquad ( 13 )$$

$${W}_{k} ≡ \frac{{‖ {I}_{k} - ( - j ) {Q}_{k} ‖}_{2}}{{‖ {I}_{k} ‖}_{2}} , where {‖ {I}_{k} ‖}_{2} \neq 0$$

$$or$$

$${W}_{k} ≡ \frac{{‖ {I}_{k} - ( - j ) {Q}_{k} ‖}_{2}}{{‖ {Q}_{k} ‖}_{2}} , where {‖ {Q}_{k} ‖}_{2} \neq 0$$

As described above, the electromagnetic noise may enter one of the I-axis ADC 14 and the Q-axis ADC 15. In a case of certain k, it cannot be said that a Fourier transform result does not become 0 at all on the axis that the electromagnetic noise does not enter. So-called normalization is performed in the equation (13) by dividing two norms given by the equation (10) by two norms of Iₖ or two norms of Qₖ. The equation (13) indicates a case where the two norms are divided by two norms of Iₖ or a case where the two norms are divided by the two norms of Qₖ, to avoid division by zero.

Although the equation (13) gives the normalized cancellation constant (weight and Wₖ), the technique of the present disclosure is not limited thereto. The radar device according to the technology of the present disclosure may use the cancellation constant (weight and Wₖ) that is not normalized.

The radar device according to the technology of the present disclosure may directly extract a range bin related to a target using the conditional expression of the norm given by the equation (10).

$$for k = 1 to \frac{{N}_{\_ smpl}}{2} \qquad ( 14 )$$

$${T}_{k} ≡ \{ \begin{matrix}1 , & if {‖ {I}_{k} - ( - j ) {Q}_{k} ‖}_{2} < ε \\ 0 , & else\end{matrix}$$

It can be said that a range bin whose Tₖ given by the equation (14) is 1 is a range bin related to not an interference of electromagnetic noise but a target (see the two-dimensional FFT lattice diagram in FIG. 10).

### <<Distance/Speed Spectrum Calculation Unit 1620B of Signal Processing Unit 16>>

The distance/speed spectrum calculation unit 1620B of the signal processing unit 16 is a component that performs Doppler Fourier transform and calculates a distance/speed spectrum (ST33 illustrated in FIG. 9) similarly to the distance/speed spectrum calculation unit 1620. In this regard, unlike the distance/speed spectrum calculation unit 1620, a target that the distance/speed spectrum calculation unit 1620B performs Doppler Fourier transform on may be only a range bin whose Tₖ given by the equation (14) is 1.

Furthermore, as illustrated in FIG. 10, the distance/speed spectrum calculation unit 1620B may eliminate an influence of electromagnetic noise using the cancellation constant (weight and Wₖ) calculated by the cancellation constant calculation unit 1670, and then perform Doppler Fourier transform.

As described above, technical features unique to the radar device according to Embodiment 3 include determining using the conditional expression of the norms given by the right side of the equation (10) whether or not the I-axis beat signal and the Q-axis beat signal that have been actually sampled and measured are the real part and the imaginary part of the analytic signal.

The radar device according to Embodiment 3 has these technical features, and provides an effect that that it is possible to eliminate the influence of an interference of electromagnetic noise from a two-dimensional FFT result in addition to the effects described in Embodiment 1 and Embodiment 2.

### Embodiment 4

A radar device according to Embodiment 4 is a modification example of the radar device according to the technology of the present disclosure. Unless clearly indicated in particular, the same reference numerals as those in the existing embodiments will be used in Embodiment 4. Furthermore, Embodiment 4 will omit description that overlaps those in the existing embodiments as appropriate.

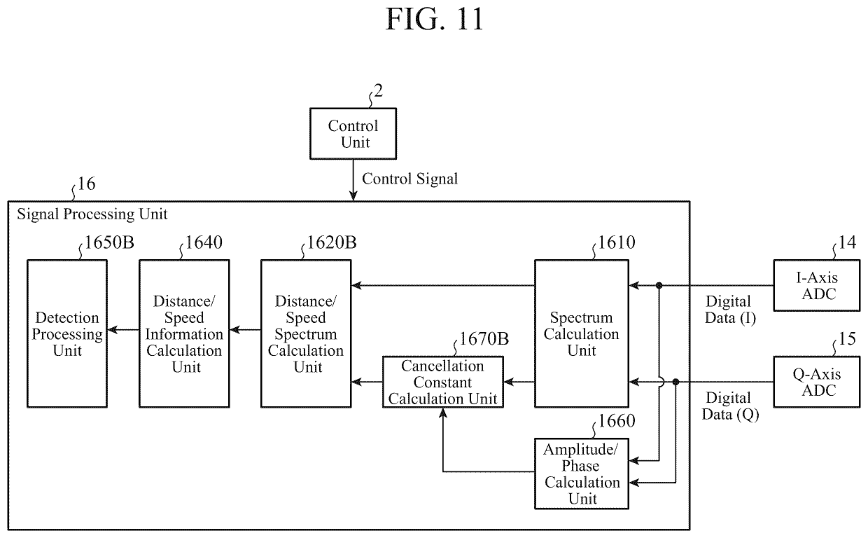

FIG. 11 is a block diagram illustrating a detailed configuration of a signal processing unit 16 of a radar device according to Embodiment 4.

Upon comparison between FIG. 11 and FIG. 8 (Embodiment 3), the signal processing unit 16 according to Embodiment 4 includes as a component a cancellation constant calculation unit 1670B in place of the cancellation constant calculation unit 1670. The cancellation constant calculation unit 1670B receives an input of information from the spectrum calculation unit 1610.

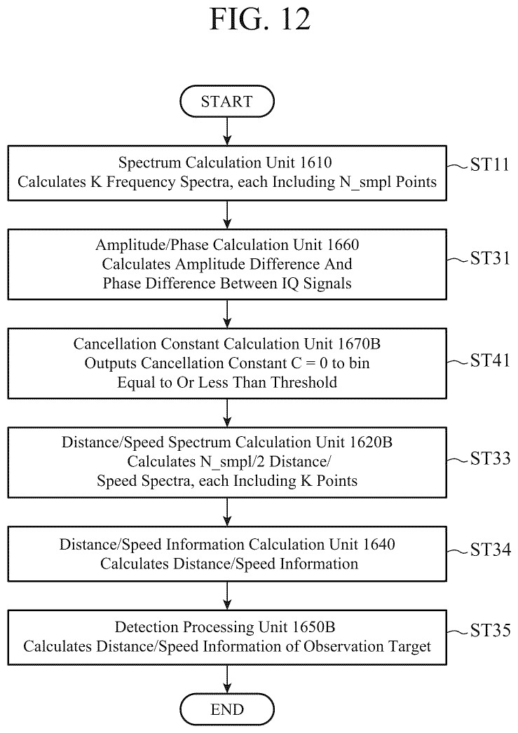

FIG. 12 is a flowchart illustrating processing steps performed by the signal processing unit 16 of the radar device according to Embodiment 4.

Upon comparison between FIG. 12 and FIG. 9 (Embodiment 3), the signal processing unit 16 according to Embodiment 4 performs ST41 instead of ST32.

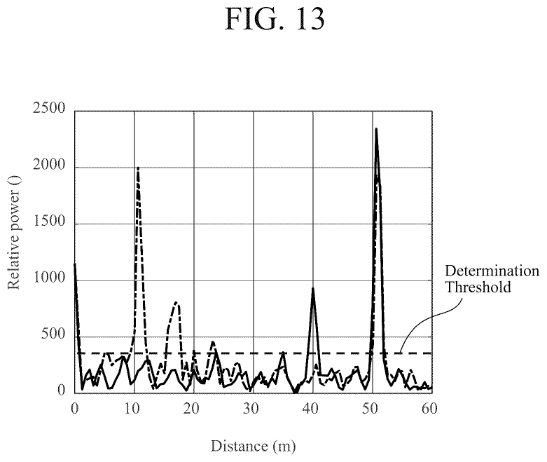

FIG. 13 is a view for describing processing contents performed by the signal processing unit 16 of the radar device according to Embodiment 4. More specifically, a graph illustrated in FIG. 13 shows a frequency spectrum calculated by the spectrum calculation unit 1610. The horizontal axis in the graph indicates a range (indicated as “Distance” in FIG. 13) proportional to a beat frequency, and a unit thereof is [m]. The vertical axis in the graph indicates relative power (indicated as “Relative power” in FIG. 13) of a spectrum. In the graph exemplified in FIG. 13, a broken line indicates positive domain frequency spectrum data, and a solid line indicates negative domain frequency spectrum data by inverting the sign of the frequency axis.

As exemplified in FIG. 13, a spectrum peak appearing near 10 [m] of the distance appears only in the positive domain frequency spectrum data, and is an example of a peak caused by a target. By contrast with this, a spectrum peak appearing near 50 [m] of the distance appears both in the positive domain frequency spectrum data and the negative domain frequency spectrum data, and is an example of a peak caused by electromagnetic noise. Furthermore, as exemplified in FIG. 13, a spectrum peak appearing near 40 [m] of the distance appears only in the negative domain frequency spectrum data, and is an example of a secondary peak.

Although the spectrum calculation unit 1610 calculates the frequency spectrum by performing range FFT on the complex digital data expressed in the equation (4), this frequency spectrum can be expressed as follows, for example.

$$ℱ [ \{ \begin{matrix}{c}_{1} , & … , & {c}_{N \_ smpl}\end{matrix} \} ] = \{ \begin{matrix}{S}_{1} , & … , & {S}_{N \_ smpl}\end{matrix} \} \qquad ( 15 )$$

Here, the left side of the equation (15) is complex digital data in the time domain, and lower right subscript numbers 1 to N_ₛₘₚₗ are assigned in order of a lapse of time. Here, the right side of the equation (15) is frequency spectra {S₁, . . . , S_{N_smpl}} indicated in the frequency domain, and lower right subscript numbers 1 to N_ₛₘₚₗ are assigned in a direction from a higher positive frequency to a negative frequency.

### <<Cancellation Constant Calculation Unit 1670B of Signal Processing Unit 16>>

The cancellation constant calculation unit 1670B of the signal processing unit 16 is a component that calculates a cancellation constant (weight) for canceling a component caused by electromagnetic noise per range bin similarly to the cancellation constant calculation unit 1670.

The cancellation constant calculation unit 1670B may calculate a cancellation constant (weight and Wₖ) on the basis of a following conditional expression instead of the conditional expression expressed in the equation (10).

$$for k = 1 to \frac{{N}_{\_ smpl}}{2} \qquad ( 16 )$$

$${W}_{k} ≡ \{ \begin{matrix}0 , & if {‖ {S}_{k} ‖}_{2} < ϵ \\ 1 , & else\end{matrix}$$

An epsilon appearing in the conditional expression of the equation (16) is a threshold expressed as a broken line indicated as a “determination threshold” in the graph in FIG. 13.

Technical features unique to the radar device according to Embodiment 4 include comparing the magnitude of the frequency spectrum acquired by range FFT, and the threshold (see the equation (16)).

The radar device according to Embodiment 4 has these technical features, and provides an effect similar to the effects described in the existing embodiments.

### Embodiment 5

A radar device according to Embodiment 5 is a modification example of the radar device according to the technology of the present disclosure. Unless clearly indicated in particular, the same reference numerals as those in the existing embodiments will be used in Embodiment 5. Furthermore, Embodiment 5 will omit description that overlaps those in the existing embodiments as appropriate.

A peak signal caused by electromagnetic noise among frequency spectra obtained by performing range Fourier transform on complex digital data is separated into the positive frequency domain and the negative frequency domain, and is given according to the following equation.

$${P}_{+} = \frac{N}{2} \{ ( cos {θ}_{1} + Asin {θ}_{2} ) - j ( sin {θ}_{1} - Acos {θ}_{2} ) \qquad ( 17 )$$

In this regard, “P+” on the left side of the equation (17) represents a peak signal in the positive frequency domain, “A” represents an amplitude ratio of the I-axis beat signal and the Q-axis beat signal, “θ₁” represents an initial phase of the I-axis beat signal, and “θ₂” represents an initial phase of the Q-axis beat signal.

$${P}_{-} = \frac{N}{2} \{ ( cos {θ}_{1} - Asin {θ}_{2} ) - j ( sin {θ}_{1} + Acos {θ}_{2} ) \} \qquad ( 18 )$$

In this regard, “P₋” on the left side of the equation (18) represents a peak signal in a negative frequency domain.

The technology of the present disclosure may perform processing of canceling the peak signal (P₊) in the positive frequency domain by multiplying the certain cancellation constant (C) on a complex conjugate of P₋ given by the equation (18). A conditional expression that the cancellation constant (C) needs to satisfy is given as follows.

$$C \overline{{P}_{-}} = {P}_{+} \qquad ( 19 )$$

$$∴ C = \frac{{P}_{+}}{\overline{{P}_{-}}} = \frac{{P}_{-} {P}_{+}}{{P}_{-} \overline{{P}_{-}}} = \frac{1 - {A}^{2} + 2 j Acos ( {θ}_{1} - {θ}_{2} )}{1 + {A}^{2} + 2 Asin ( {θ}_{1} - {θ}_{2} )}$$

Here, an accent symbol of a bar in the equation (19) represents a complex conjugate.

Technical features unique to the radar device according to Embodiment 5 include multiplying the cancellation constant (C) given by the equation (19) on the complex conjugate of the peak signal (P₋) in the negative frequency domain.

The radar device according to Embodiment 5 has these technical features, and provides an effect similar to the effects described in the existing embodiments.

### INDUSTRIAL APPLICABILITY

The radar device according to the technique of the present disclosure is applicable to, for example, an in-vehicle millimeter wave radar, and has industrial applicability.

### REFERENCE SIGNS LIST

1: Radar signal output unit, 2: Control unit, 3: Signal source, 4: Transmission/reception unit, 5: Distribution unit, 6: Transmission antenna, 7: Reception antenna, 8: Beat signal generation unit (Beat signal generator), 9: 90-degree phase shifter, 10: I-axis frequency mixing unit, 11: Q-axis frequency mixing unit, 12: I-axis filter unit, 13: Q-axis filter unit, 14: I-axis ADC, 15: Q-axis ADC, 16: Signal processing unit (Signal processor), 1610: Spectrum calculation unit, 1620 and 1620B: Distance/speed spectrum calculation unit, 1625 and 1625B: Electromagnetic noise spectrum calculation unit, 1630: Distance/speed information calculation unit, 1635: Electromagnetic noise information calculation unit, 1640: Distance/speed information calculation unit, 1650 and 1650B: Detection processing unit, 1660: Amplitude/phase calculation unit (Amplitude/phase calculator), 1670 and 1670B: Cancellation constant calculation unit (Cancellation constant calculator)

What is claimed is:

1. A radar device of an FMCW system or a fast chirp system comprising:
a beat signal generator to generate an I-axis local oscillator signal and a Q-axis local oscillator signal from a local oscillator signal that is a real signal, mix the I-axis local oscillator signal and a received signal to generate an I-axis beat signal, and mix the Q-axis local oscillator signal and the received signal to generate a Q-axis beat signal; and
a signal processor to perform signal processing on I-axis digital data and Q-axis digital data obtained by sampling the I-axis beat signal and the Q-axis beat signal,
wherein the signal processor generates complex digital data from the I-axis digital data and the Q-axis digital data, performs FFT on the complex digital data, and measures a range and a Doppler velocity of an observation target on a basis of a property that an analytic signal does not have a negative frequency component,
wherein the radar device further comprises: an amplitude/phase calculator to perform range FFT on each of the I-axis digital data and the Q-axis digital data; and a cancellation constant calculator to calculate a cancellation constant for canceling a component caused by electromagnetic noise per range bin on a basis of a processing result of the amplitude/phase calculator.

2. The radar device according to claim 1, wherein
the cancellation constant is Wₖ given by
$$for k = 1 to \frac{{N}_{\_ smpl}}{2} \qquad ( 10 )$$
$${W}_{k} ≡ \{ \begin{matrix}0 , & if {‖ {I}_{k} - ( - j ) {Q}_{k} ‖}_{2} < ε \\ 1 , & else\end{matrix}$$
wherein 1 to N_ₛₘₚₗ/2 are numbers of range bins related to a positive frequency domain, and an epsilon represents a threshold for determining an error to be permitted, Iₖ is the I-axis beat signal that has been actually sampled and measured, and Qₖ is the Q-axis beat signal that has been actually sampled and measured.

3. The radar device according to claim 1, wherein
the cancellation constant is Wₖ given by
$$for k = 1 to \frac{{N}_{\_ smpl}}{2} \qquad ( 13 )$$
$${W}_{k} ≡ \frac{{‖ {I}_{k} - ( - j ) {Q}_{k} ‖}_{2}}{{‖ {I}_{k} ‖}_{2}} , where {‖ {I}_{k} ‖}_{2} \neq 0$$
$$or$$
$${W}_{k} ≡ \frac{{‖ {I}_{k} - ( - j ) {Q}_{k} ‖}_{2}}{{‖ {Q}_{k} ‖}_{2}} , where {‖ {Q}_{k} ‖}_{2} \neq 0$$
wherein 1 to N_ₛₘₚₗ/2 are numbers of range bins related to a positive frequency domain, Iₖ is the I-axis beat signal that has been actually sampled and measured, and Qₖ is the Q-axis beat signal that has been actually sampled and measured.

4. The radar device according to claim 1, wherein
the cancellation constant is Wₖ given by
$$for k = 1 to \frac{{N}_{\_ smpl}}{2} \qquad ( 16 )$$
$${W}_{k} ≡ \{ \begin{matrix}0 , & if {‖ {S}_{k} ‖}_{2} < ϵ \\ 1 , & else\end{matrix}$$
wherein 1 to N_ₛₘₚₗ/2 are numbers of range bins related to a positive frequency domain, Sₖ represents a frequency spectrum obtained by performing Fourier transform on the complex digital data, and an epsilon represents a threshold that is compared with a magnitude of the frequency spectrum obtained by performing Fourier transform on the complex digital data.

5. The radar device according to claim 1, wherein
the cancellation constant is C given by
$$C \overline{{P}_{-}} = {P}_{+} \qquad ( 19 )$$
$$∴ C = \frac{{P}_{+}}{\overline{{P}_{-}}} = \frac{{P}_{-} {P}_{+}}{{P}_{-} \overline{{P}_{-}}} = \frac{1 - {A}^{2} + 2 j Acos ( {θ}_{1} - {θ}_{2} )}{1 + {A}^{2} + 2 Asin ( {θ}_{1} - {θ}_{2} )}$$
wherein P₊ represents a peak signal in a positive frequency domain, P₋ represents a peak signal in a negative frequency domain, “A” represents an amplitude ratio of the I-axis beat signal and the Q-axis beat signal, θ₁ represents an initial phase of the I-axis beat signal, and θ₂ represents an initial phase of the Q-axis beat signal,
the cancellation constant is multiplied on a complex conjugate of P₋ to cancel P₊.
